(19) United States
(12) Patent Application Publication
(10) Pub. No.: US 2006/0028327 A1
(43) Pub. Date: Feb. 9, 2006

(54) Wireless replication, verification, and tracking apparatus and methods for towed vehicles

(76) Inventor: Delbert Amis, Surfside Beach, SC (US)

Correspondence Address: MCNAIR LAW FIRM, PA, P.O. BOX 10827, GREENVILLE, SC, 29603-0827, US

(21) Appl. No.: 11/197,088

(22) Filed: Aug. 4, 2005

Related U.S. Application Data
(60) Provisional application No. 60/599,994, filed on Aug. 9, 2004.

(51) Int. Cl. G08B 21/00; B60Q 1/26

(52) U.S. Cl. 340/431; 340/468

(57) ABSTRACT

In some preferred embodiments, a smart socket adapter is utilized. The male plug on the towed end of the wiring harness is unplugged from the female tow port that is part of the towed vehicles wiring package. A smart socket adapter is inserted into the towed unit's female tow port and the wiring harness male plug is then plugged into the new adapter. Preferred embodiments of this adapter have smart circuits that transmit wireless signals to a verification device that is located in the towing unit. Advantages of the present invention include facilitation of a safer tow operation, because the towing operator will know at all times if the integrity of the tow connections and replication of signals has been maintained. In another embodiment, a wireless transmitting smart plug is plugged onto a standard wiring socket on the towing unit and a wireless receiving smart plug is plugged into a standard wiring socket on the towed unit. Replication of the command signal at the receiving unit is accomplished by utilization of the receiving unit's existing wiring in conjunction with the addition of a power source to run the lights. Verification of receiver unit signal activation is accomplished by utilization of the same additional power source. In yet another embodiment, command signal replication and verification is accomplished by replacing brake, turning signal, and running light bulbs in both the command and the receiving units with smart bulbs that communicate with each other. In still another embodiment, command replication and verification is accomplished by the addition of smart bulb sockets in both the command and the receiver units that communicate with each other. In yet a further embodiment, signal replication and verification can be accomplished by utilizing the receiving unit's existing wiring with no additional power source. In such embodiments, an identification chip may further be integrated therein.

### CROSS REFERENCE TO RELATED APPLICATION

This application is based on and claims priority from provisional application Ser. No. 60/599,994 filed Aug. 9, 2004.

### BACKGROUND OF THE INVENTION

The present invention relates generally to improved safety and reliability of turn signals, brake lights, and running lights for vehicles in tow, and more specifically to improved methods of signal verification and monitoring by the towing driver of the towing vehicle's signals and of the signals replicated at the towed vehicle. Additionally, the invention relates to systems for tracking both the towing and the towed vehicles.

Electrical towing systems are in wide-spread use in many applications. For example, rental trailers, boat trailers, utility trailers, and automobiles as towed behind motor homes, are some of the current uses. In many instances, two very different electrical systems are present in the towing and the towed units, and which thus require proper and compatible electrical connection to assure reliability of signal replication therebetween. The differences in structure and operation between the two electrical systems can involve significant expense to join the two systems electrically. Also, joinder of such substantially different systems can lead to premature failure of the joined or individual systems. Yet further, once the two signal units have been electrically connected, there is a further need to assure that the connections are to be sustained, as motor vehicle regulations often require lighting on the rear of a towed unit to be controlled by the towing unit.

In such instances, verification that the electrical signal has been and continues to be transmitted to the towed vehicle may likely be desirable or necessary. However, in many cases, signal verification can be readily accomplished only at the beginning of the towing trip. Thereafter, the connection between the two signal units may come loose during operation without the driver's knowledge. The present invention preferably includes as a feature thereof the continuous monitoring of the signal integrity from the time of (a) the initial hook-up, and (b) through the subsequent uncoupling of the two electrical systems.

In addition to having (a) reliable signal replication between the towing and the towed vehicles, and (b) verification of the operability of the signals to the operator of the towing vehicle, the presence of the additional feature of an associated anti-theft system may also be of substantial benefit to owners and users of towing vehicles, in preferred embodiments. By way of background, towed vehicles are often left uncoupled and unattended. These unattended and uncoupled vehicles can in some circumstances constitute easy theft targets, as the majority of the hitching parts of towing apparatus often are standard and/or easily adapted. As a result, many newer vehicle models are now being equipped with both anti-theft devices and with tracking chips. However, the majority of older vehicles have not been equipped with either anti-theft or location chips. This is moreover especially true for boat trailers and utility trailers, where most do not have anti-theft or locator systems.

In view of the defects and disadvantages of prior art systems, improvement has been sought. In particular, the towing industry has sought suitable, economic and efficient means to reliably replicate, inter alia, the turning light, the brake light, and the running light signals in a towed vehicle when the corresponding light signal of a towing vehicle is activated. For example, (a) when the left turning light of the towing vehicle is activated, then the left turning light of the towed vehicle is also activated, and (b) when the left turn light is switched off in the towing vehicle, then the towed vehicle's left turn light is also switched off. Moreover, at the present time, continuous and effective system verification or anti-theft capability refine similar improvement.

In the prior art, each of U.S. Pat. No. 6,100,801 to Plummer and U.S. Pat. No. 2002/0082750 to Lamke. et al. relates to various aspects of wireless signal systems for towing vehicles. The Plummer patent consists of a portable light bar including a set of lights for each function of braking, turning signals, and running lights. The bar is magnetically affixable and electrically connected to the braking, turning, and tail lighting systems of a trailer or towed vehicle. Inasmuch as many vehicles have non-metallic surfaces, the bars are attached with straps. Currently, such portable light bar systems can be problematical, due to the inconvenient nature of its design. Also, such wireless bar systems are generally lacking in effective verification and/or anti-theft features.

The Lamke patent also refers to a wireless transmitting/receiving system between a first and a second vehicle, and makes reference to the replication being accomplished through connection to the second vehicle's lighting system. In a second embodiment, replication is accomplished through a separate light bar mounted to the second vehicle, similar to that shown in the Plummer patent, supra.

These prior art systems may have a certain utility for the intended towing purposes. However, substantial disadvantages are present which could be the subject of substantial improvement. For example, neither of these prior art patents teaches or suggests the use of signal verification on the towed vehicle. In contrast, not only is signal verification a desirable and integral part of certain preferred embodiments of the present invention, but such verification in these and other embodiments is accomplished in such a way that the towing operator can continually monitor the lighting system of the towing or the towed vehicle at any time. A second fundamental difference of such embodiments over these prior art systems is a unique and/or improved anti-theft feature. Another significant feature of certain embodiments of the present invention is the use of off-the-shelf components put together in a substantially unique arrangement, and to accomplish a substantially new and/or different purpose.

Additionally, many of the prior art wiring configurations can add extra load on the towing unit's wiring system, thereby resulting in blown fuses, burnt wires, signal malfunction, etc., which can cause electronic devices, such as “lamp-out” sensors, for example, to react falsely. Also, the extra load on the towing unit's electrical system may necessitate the addition of a power converter or power isolator to protect the sensitive electronic systems of many new vehicles from damage. Moreover, in the prior art, electrical connections between the towing and the towed units are frequently made on the outside of the units, thus exposing the connection to the elements.

Many factors can affect the continuity of operation of towing electrically connected signal systems. Connectors can come apart while the vehicles are being operated, and often without the knowledge of the driver in the towing unit. Connectors may corrode, thus making electrical contact difficult or requiring a new connector. On boat trailers, connectors may be completely submerged while loading or unloading a boat, thus causing blown fuses or other continuity issues. Additionally, mechanical damage of the connection wiring can occur due to outside exposure and potential for rough treatment.

Yet additionally, connecting two units with incompatible electrical systems can cause further operational difficulties, plus add yet further installation costs. For example, the various different makes of towing vehicles and the many different towed units typically have different wiring specifications and electrical system operating requirements. Accordingly, these many potential towing/towed vehicle combinations make it virtually impossible to have a single universal configuration that fits all needs.

In the prior art, costs further accelerate when special diodes, power boosters, tail light converters, heavy-duty flashers, heavier wire, or other differences from the standard wiring package, are required. Accordingly, by utilizing the respective electrical systems of the towing and towed units as independent operating systems, and only connected by radio signals, many of the prior art negatives and disadvantages may be reduced or eliminated. Additionally, other differentiating characteristics of preferred, alternative and other embodiments of the improved towing signal apparatus and methods of the present invention will become apparent to those skilled in the art upon review of the following description of the invention.

### SUMMARY OF THE INVENTION

The present invention is directed to a safer and improved wireless system for simultaneous activation and verification of rear vehicle lights on both a towing and a towed vehicle, and for vehicle location in the event a vehicle is lost or stolen. In preferred embodiments, the system combines currently available items with new apparatus in a unique arrangement that facilitates continuous signal verification and monitoring, signal transmission, signal receiving, and vehicle location. Several preferred methods and apparatus, as well as alternative embodiments, offer features which are included within the scope of the present invention, as described herein.

One advantage of certain embodiments of the present invention is to provide means to monitor rear light signals on a towing and towed vehicle in a manner where the towing driver can easily observe the verification monitor. In many cases, the monitoring device will be a portable hand-held unit. In some preferred embodiments, a “Bluetooth” environment is created around the towing and the towed vehicles, where wireless signals are transmitted, received, verified, and monitored inside this environment. Bluetooth technology offers unique stand-alone playing fields, and thus the possibility of overlapping signals between adjacent sets of towed vehicles is minimal. The Bluetooth technology is only one of many technologies that can be used to accomplish sending and receiving of signals for rear light verification and replication.

Another advantage of such embodiments of the improved invention hereof is to provide a means to add signal verification to prior art tow installations where hard-wired standard wiring harnesses are used. Embodiments of this invention accomplish these and other functions by adding a dual function, wireless smart adapter to the wiring harness that connects the towing and the towed vehicle electrical systems. The smart adapter is added at the interface where the current art wiring harness would plug into the towed vehicle's tow plug. The smart device is designed to plug directly into the vehicle's existing tow plug on one end and designed to accept the harness plug on the other end. Internal circuits in the smart plug detect when an electrical signal is sent through the harness wire. These circuits then activate wireless switches to send wireless signals to the verification monitoring device in the towing unit. In these embodiments, each different function of braking, turning and running lights has a distinct and separate wire for that function. The wireless adapter also has distinct and separate wireless switches and signals for each function.

Still another advantage of such embodiments is to provide the means wherein a simple bulb replacement in both the towing and the towed vehicles will facilitate wireless signal replication and verification. These embodiments of the invention provide the means where matching sets of wireless smart bulbs are installed to provide brake, running light, and turn signal replication. Also, the smart receiving bulbs provide the prime feature of signal verification by sending wireless signals to the verification monitoring device in the towing unit. A locator chip is added to one of the bulbs to facilitate locating the vehicle. By adding this feature to the bulb circuits, it becomes much more difficult to be disabled by a thief. Bluetooth, radio frequency (RF), or other similar systems are used in certain embodiments as the wireless technology. An added benefit of these advantages is that having the wireless apparatus inside the rear light enclosure can improve resistance to mechanical and/or weather damage.

Another advantage of such embodiments is to provide a further alternative to smart bulbs and still have the wireless apparatus completely enclosed. Such embodiments of the present invention accomplishes this objective by means of a wireless smart socket adapter. The wireless smart adapter is plugged directly into the original equipment bulb socket and then an ordinary bulb fits into the smart adapter. All wireless circuits including the verification and locator circuits are printed into the adapter design. As with the smart bulbs, it is necessary to install the smart sockets in pairs to facilitate proper signal replication. The features and benefits of this apparatus and supporting system are similar to those of the smart bulb apparatus.

Still another advantage includes weather and mechanical damage protection for embodiments that are not installed inside the rear light enclosures. Embodiments of the present invention include the means to place the smart device inside either the towing unit or the towed unit. Smart devices can be placed inside a towed or towing unit and an extra long length of connecting wire is plugged into the device and then into the tow port installed on the vehicle. This will facilitate having all the smart circuits out of weather and harms way.

Another beneficial feature of some preferred embodiments of the present invention includes the means to locate either the towing or the towed vehicles in case of loss or theft. This functioning is accomplished by strategic placement in the wireless circuitry of a GPS or similar chip. The GPS or other similar location device is activated as needed to locate one or both of the tow vehicles. The GPS system is activated and GPS signals tracked using the verification/monitoring panel.

Yet another advantage is the inclusion of wireless signals that are distinguishable from other similar signals. It is possible that sets of towed vehicles could be close enough to each other that, if both had wireless systems, their signals could get confused, and thus the integrity of the rear light functions would be compromised. Such advantageous embodiments of the present invention provide in the wireless circuits a random signal generator that rewrites signals each time a new signal is read. For example, when the right turn signal in the towing unit is activated, a wireless signal is sent to the wireless receiver device and the receiver device replicates the right turn signal in the towed vehicle, and at the same time when this wireless signal is read by an encoder unit a new signal at a different frequency is generated. With this unique feature, signal overlapping will be substantially reduced.

Another advantage is to provide an auxiliary 12 volt power source to run the rear lights in the towed vehicle. Applications where the wiring harness between the towing and the towed vehicles is replaced with wireless apparatus may require additional battery power to run the rear lights on the towed vehicle. Such preferred embodiments of the present invention provide the means to add a rechargeable 12v battery directly in the wireless circuits that will in turn provide power as needed to run the vehicles rear lights. The 12 volt rechargeable battery is only one of many technologies that can be used to provide power to the towed unit's lights.

Still a different advantage includes the provision of wireless apparatus to replace all wiring between the towed and the towed vehicles with minimum installation. These embodiments provide this advantage by means of adding wireless smart plugs that plug directly into the plug adapters on the towing and the towed vehicles. Complete installation consists of removing the wiring harness and plugging in two plugs. In addition the wireless smart plugs have the added features of sending verification signals to the verification monitor and of having embedded locator chips in the wireless circuits.

A further advantage of embodiments of the present invention is the provision of signal integrity while moving and during adverse weather. For such embodiments, apparatus is designed with enclosures that provide weather and mechanical damage protection. Such embodiments of the invention also provide strapping or other equipment to secure external plugs and adapters. Maintaining signal integrity is primary to towing light safety and signal replication and these embodiments provide the means to accomplish the needed integrity.

In addition to the previously mentioned advantages and/or features, the further feature of design and operating simplification has been of substantial benefit. This advantage has been accomplished, with simple installation for all apparatus by (a) combining proven technologies in such a way as to introduce new end uses, (b) adding high tech features in such a way as to make the addition relatively inexpensive—such as the locator chip that uses GPS for theft deterrent, and (c) using component parts that are readily available should replacement be required.

In summary, and as to certain preferred and alternative embodiments, once installed on both the towing and the towed vehicles, the towing vehicle operator can activate the turning signal function on the towing vehicle. As a result, a wireless signal, via radio frequency (RF) in some preferred embodiments, is sent to the corresponding turning function element of the towed vehicle. Once activated, the towed vehicle mechanism will send a wireless verification signal back to the towing vehicle. This verification signal activates preferably a light emitting diode (LED) on a portable verification screen, which in some preferred embodiments may be hand-held. The portability feature of the screen has the advantage of reliable monitoring of the signaling system from inside the vehicle and/or from a more remote location. The locator feature of the system is to be activated only when needed. In the event the vehicle is lost or stolen, the locator tab on the hand-held verification display can be turned on to activate a GPS chip or an “On-Star” chip or a passive radio frequency identification (RFID) tag or other similar locator chips, which is part of the receiving transmitter installed on the towed vehicle. Similarly, in some preferred embodiments, the rear light functions of the towing vehicle can be monitored on the verification screen.

In one preferred embodiment, the wireless tow installation package may comprise: (a) a matched set of smart male plugs (which may include one male, wireless smart sender that plugs into an existing female 4, 6, or 7 way receptacle on the towing vehicle, and one male, wireless smart receiver that plugs into an existing female 4, 6, or 7 way receptacle on the towed unit), and associated wiring to match the towing unit if the unit is not already wired; (b) a 12v power supply to power the towed unit's rear lights; (c) a smart module in the towed unit to send notification that command signals were received and are activated, together with a corresponding verification smart receiving module in the towing vehicle, and further including a portable unit for verifying that the various functions of the system are operational; (d) adapters to facilitate using the male smart plugs with the majority of the female plugs used for tow installations; and in preferred embodiments (e) a storage case for all components.

These and other embodiments will thus power the towed unit's electrical system without adding load to the towing vehicle's electrical wiring, thus reducing substantially the prior art difficulties associated with over-loading the towing vehicle's electrical system. Also, prior art problems associated with hard-wired connections will likewise be substantially reduced or eliminated, as no hard wiring between the towing and the towed unit's respective electrical systems is required. With the verification feature, these and other embodiments will function to substantially reduce or eliminate the issue of not knowing if the signals are working during the operating mode.

In another embodiment, the wireless tow installation package may consist of: (a) a matching set of wireless smart bulb sockets, with one set of sockets, having built-in transmitting circuits, installed in the towing unit and a matching set of receiver sockets installed in the towed unit. Installation of this embodiment would consist of removing existing bulbs, screwing in the smart sockets and reinstalling the bulbs. The remainder of the package would be similar to elements (b)-(e) of the above described embodiment.

In still another embodiment the wireless installation package may consist of (a) a smart transmitting adapter installed in the towed unit's wiring harness, (b) a new Velcro strap to improve plug-in reliability, and (c) a receiver verification panel located with the towing unit's operator. This verification panel will assure that the operator knows the status of the signal integrity for the towed unit at all times. Hard wiring between the towing and the towed units would not be replaced in this signal verification embodiment. The wiring harness at the towed unit would be plugged into the smart socket and perform all functions as before. Thus, this embodiment is different from other such embodiments in that light signal functions are not changed in anyway, and instead verification of the signals is the prime motivation.

In yet another alternative embodiment of the present invention, the wireless tow installation package apparatus of the present invention comprises: (a) a matching set of wireless smart bulbs, with one set of sender bulbs to be installed in the towing vehicle, and one set of receiver bulbs to be installed in the towed unit; (b) a 12v power supply to power the towed unit's rear lights; (c) a notification module in the receiving unit and a verification module in the towing unit [and similar to the apparatus described at element (c), above] for verifying that the various functions of the apparatus are properly working; (d) socket adapters to facilitate using the smart bulbs to replace the majority of the bulbs used for rear lights; and preferably (e) a storage case for all components. This latter embodiment substantially reduces any prior art issues associated with hard-wired connections and further more substantially eliminates all prior art issues associated with power overloads to the towing vehicle's wiring system.

In yet a further embodiment, a location function is added to the smart plug on both the towing and the towed unit to facilitate tracking the towing vehicle or the towed unit in the event of theft.

In another embodiment, a location locator function is added to one of the sending smart bulbs and one of the receiving smart bulbs to facilitate tracking the towing vehicle or the towed unit in the event of loss or theft.

Such locator feature may also be utilized in conjunction with the smart bulb socket embodiment and or the smart adapter embodiment, as described, supra.

In an additional embodiment, the smart technology modules are used to activate portable lights that are attached to the towed unit.

Many variations of these and other preferred and alternative embodiments of the apparatus and methods of the present invention will be apparent to those skilled in the art upon review of the disclosure hereof.

Accordingly, inter alia, several exemplary features and/or advantages of embodiments of the present invention are presented. For example, operating safety will materially improve with continuously monitoring the integrity of rear signal lights. For certain preferred embodiments, reliability of both the towing and towed vehicle electrical systems will be substantially improved, as in these embodiments of the invention the two systems will not be directly coupled. In the certain preferred embodiments, system failure due to mechanical damage would be greatly reduced with the use of wireless signal transmissions verses the current and prior art hard wired packages. Another advantage of the present invention is the additional feature of activating a location chip. Still further features and advantages will become apparent from a study of the following description and accompanying drawings.

The following detailed description in not intended to be all inclusive of all possible embodiments of the present invention, but is given as examples of how some preferred embodiments of the invention function, and accordingly does not in any way limit the invention. One skilled in the art will be enabled to make and use the preferred embodiments described herein. Included are several variations, alternatives, uses, and suggestions of application and design. Diligence has been made to simplify the invention, where possible, by suggested use of proven technologies, which may be incorporated by reference herein but without limiting the invention to any one method of manufacturing or design component.

### BRIEF DESCRIPTION OF THE DRAWINGS

FIG. 1 is an elevation view of a towing vehicle and a towed vehicle showing the respective locations of smart devices and associated items;

FIG. 2 is a schematic representation of the portable verification/locator device of the present invention;

FIG. 3 is a schematic representation of the smart wireless sending plug of the present invention; and

FIG. 4 is a schematic representation of the smart wireless receiving and wireless verification and wireless locator systems of the present invention.

### DETAILED DESCRIPTION OF PREFERRED EMBODIMENTS OF THE INVENTION

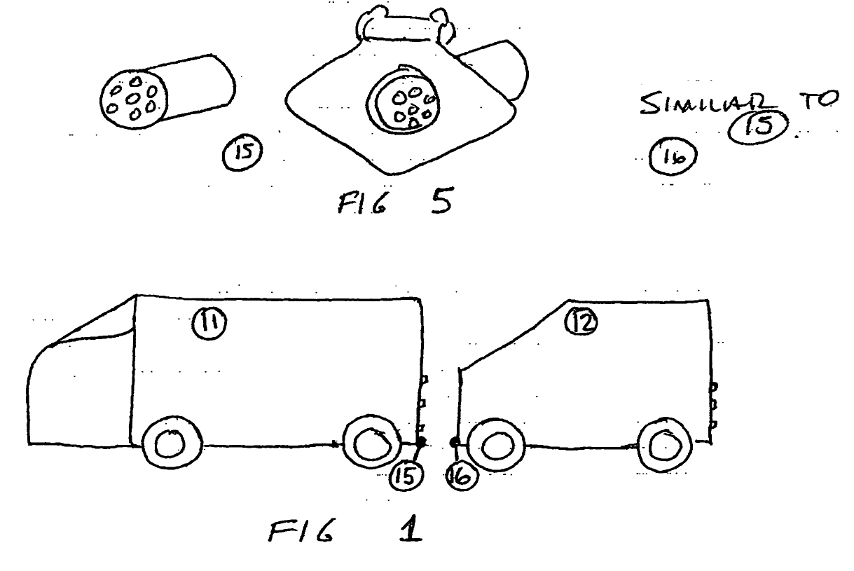

Referring to FIG. 1-4, a command or towing vehicle 21 is coupled to a towed vehicle 22 by means of conventional tow devices. Vehicle 21 has an electrical system 13 and vehicle 22 has a separate and distinctive electrical system 14. Electrical system 13, is connected to a standard female tow port 25 that is attached to vehicle 21, and electrical system 14 connected to a standard female tow port 26 that is attached to vehicle 22. The electrical systems of vehicles 21 and 22 are shown connected by a standard tow harness 17 complete with male plug ends that plug into the respective vehicle female tow ports 25 and 26.

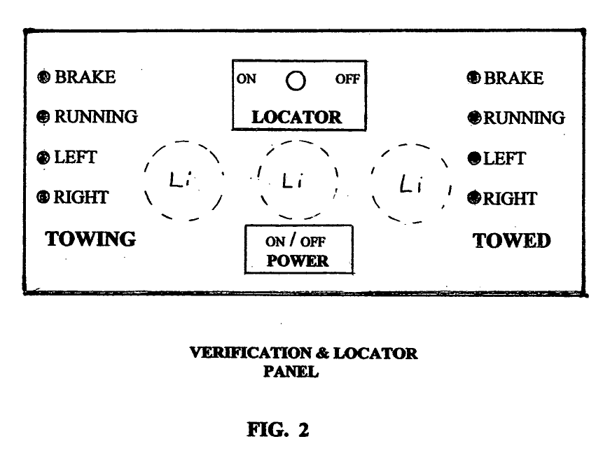

Primary to all preferred embodiments is verification that signal integrity of the towed vehicle 22 is maintained and visibly confirmed to the operator of the towing unit 21. Referring to FIG. 1, a smart adapter 18 is plugged into the female tow port 26 on towed vehicle 22, wiring harness 17 is then plugged into tow port 25 on unit 21 and into the smart adapter 18 which was plugged into tow port 26 on unit 22, thus connecting the electrical systems of the towing unit 21 and towed unit 22. Live electrical signals corresponding to brake, turn signals or running lights are sent from unit 21 through the harness 17 to unit 22, where the corresponding function is replicated once the electrical signal reaches the intended bulb on unit 22. With the addition of the present invention, specifically the smart adapter 18, a wireless verification signal (preferable RF or Bluetooth) is transmitted to and received by a receiver antenna built into the circuit of a verification panel 32 located inside towing unit 21. See FIG. 2, in particular. The printed circuits of the smart adapter 18 are designed and oriented such that when a brake signal, for example, from the towing unit 21 is activated and an electrical signal is sent through the wire of the wiring harness 17 that connects to the brake wire in the towed unit 22, a switch in the adapter 18 circuits that corresponds to brakes sends a wireless “brake on” signal to the verification panel 32. Each of the other rear light functions work similarly. In some embodiments, the wireless signals are designed with internal random code writers 36 to assure signals of other towing units 21 in close proximity are distinguishable so as not to cause issue with signal replication or verification. The entire area of the two units 21, 22 hooked together for towing may be a unique Bluetooth 35 environment to facilitate controlled wireless communication. Those skilled in the art can envision other wireless communication devices or technologies. Like in all the other embodiments a locator chip 31 is an integrated part of the wireless circuits.

When a wireless signal is transmitted from the sending plug 23 to the smart receiver plug 24, a corresponding internal switch is activated that activates a power source 28 for the towed vehicle's brake lights and the lights come on.

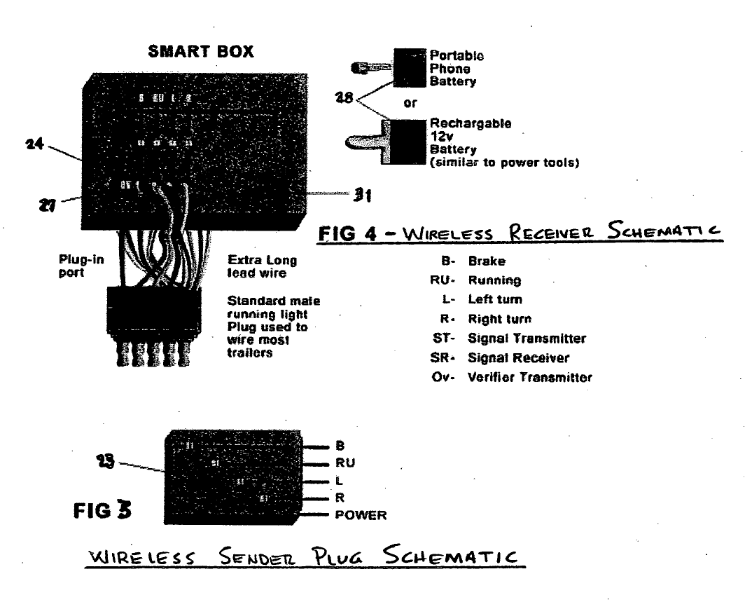

Wireless signal distinction is accomplished by predetermined matched settings for the sending and receiving functions or by adjusting the receiving unit, such as for example shown in FIG. 4, by fine tuning to the sending signal. The technology used to make the signal matching adjustments is available in many forms.

Also, included in the smart plug circuits may be a uniquely coded locator device 31, as shown in FIG. 4, which may comprise a locator chip. This locator chip will facilitate finding the plug via GPS or “On-State” technology in the event of loss or theft.

The power source for the sending unit is preferably the towing vehicle's 12v electrical system. No additional power devices for the towing unit are typically required. Embodiments of the present invention may preferably include several different power sources 28 for the towed vehicle 22 (see FIG. 4), and including methods for supplying power to run the rear lights in the towed vehicle 22. One embodiment utilizes the 12v power system of the towed vehicle 22 as the source of power to operate the rear lights for the towed vehicle 22. Another embodiment for power to run the towed vehicle's rear lights utilizes a system where a portable, preferably rechargeable, battery (see FIG. 4) is installed in the receiver smart box and is activated when any or all of the wireless signals are received. Still another embodiment may utilize a series of 1.5v long-lasting lithium batteries located in the smart box. One skilled in the art can envision additional battery combinations that can be used to provide the small amount of electrical current for operating a rear light.

As indicated, supra, GPS or “On-Star” chips are readily available in today's electronic world. One of these standard GPS chips will be incorporated in one or more of the embodiments of this invention.

As shown in FIG. 1, embodiments of the present invention may further utilize a set of wireless signal matching replacement bulbs 29, 30 for all of the rear lights on both the towing and the towed vehicles. The 4 or 6 bulbs in the towing vehicle will be replaced with a set of smart sender bulbs 29, and the 4 or 6 bulbs in the towed vehicle will be replaced with a matching set of receiver bulbs 30. The sender bulbs 29 and the receiver bulbs 30 will be used in matching pairs to ensure signal credibility. For example, if a bulb coded blue from the sender set 29 of bulbs is used for the right turning light, then the blue-coded bulb from the receiver set 30 will be used in the right turn position for the towing vehicle 21. These smart bulbs 29, 30 in preferred embodiments have the same or comparable functionality as the smart plugs 23, 24. When the towing vehicle operator steps on the brake, a wireless signal, preferably radio frequency (RF), is sent from the sender smart bulb 29 to the brake light smart receiver bulbs 30 on the towed vehicle 22 to activate this bulb. When activated, this receiver bulb 30 has a verification circuit, as for example schematically shown in FIG. 4, that will open and send a wireless signal to the verification device 32 located in the towing vehicle 21. In a similar manner, the turn signals and running lights are replicated and verified in the towed vehicle when the corresponding function is activated in the towing vehicle.

As indicated and as shown in FIG. 2, a verification monitoring device 32 is included within certain preferred embodiments of the present invention. Safe towing cannot be assured unless the towing operator can at all times monitor the performance of the towed vehicle's rear lights. One embodiment of a verification monitoring device 32 uses a standard cell phone to receive text messages from either a smart plug or a smart bulb. These devices can communicate by a Bluetooth network or similar wireless communication environment. A voice alert is a further alternative embodiment of this aspect of systems of the present invention. Another embodiment of such a monitoring device 32 may include a simple light emitting diode (LED) strip with lights that correspond to each rear lighting function. Lights on the strip thus remain in the “on” position when the corresponding towed function is active and go “off” when the rear towed light is “off”. In still another embodiment, the verification device is a screen similar to a personal data assistant (PDA) screen or hand-held calculator. Coding the verification signals into an existing on-board computer comprises another embodiment of this invention. Those skilled in the art can envision additional embodiments for receiving and displaying wireless verification signals.

In another embodiment, smart sockets 33 and 34 are inserted into the original equipment light sockets of both the towing vehicle 21 and the towed vehicle 22. This embodiment is similar to replacing the existing bulbs with smart bulbs except in this case the standard bulbs are used once the smart socket is installed. A smart sender socket 33 is inserted into the original equipment socket of the towing unit 21 and a matching receiver smart socket 34 is inserted into the original equipment light socket of the towed unit 22. As with the smart bulbs 29 and 30 the sockets come in matched sets so that signal integrity is maintained. Also each smart receiver socket 34 has a sender circuit 27 to send a verification signal to the verification device 32. The locator 31 and encoder 36 features are also part of these and other embodiments of the present invention.

While the present invention has been explained with reference to certain structure and methods as disclosed hereinabove, the present invention is not confined to the details as set forth in such preferred embodiments, and changes, modifications or variations are intended to come within the scope of the present invention and within the scope of the following claims.

What is claimed is:

1. In a wireless lighting control system between towing and towed vehicles, each having a respective lighting system, for enabling the towed vehicle to replicate the lighting condition of the towing vehicle, the improvement comprising:
lighting replication means including a wireless signal connection means disposed between the respective lighting systems of the towing and towed vehicles, and further including transmitter and receiver means operatively and physically connected to said respective lighting systems of said towing and towed vehicles.

2. The improvement of claim 1 wherein said transmitter and receiver means further comprises respective towing and towed electrical connecting means for respectively electrically interconnecting the transmitter means with the electrical system of the towing vehicle and the receiving means with the electrical system of the towed vehicle.

3. The improvement of claim 2 wherein said towing and towed electrical connecting means comprises means for physically plugging the transmitter and receiver means into respective wiring harnesses carried respectively by the towing and towed vehicles to establish an electrical signal therebetween.

4. The improvement of claim 1 further comprising verification means operatively connected to at least one of said transmitter and receiving means for indicating signal interconnection therebetween.

5. The improvement of claim 1 wherein said transmitter means comprises a transmitter socket adaptor operatively connected to said towing vehicle electrical system.

6. The improvement of claim 1 wherein said receiver means comprises a receiver socket adaptor operatively connected to said towed vehicle electrical system.

7. The improvement of claim 1 wherein said transmitter means comprises a transmitter light bulb operatively connected to said towing vehicle electrical system.

8. The improvement of claim 1 wherein a receiving light bulb is operatively connected to said towed vehicle electrical system.

9. The improvement of claim 4 wherein said verification means comprises a screen disposed within said towing vehicle for viewing by the operator thereof.

10. The improvement of claim 4 wherein said verification means includes means for indicating the operational condition of the lighting system of the towed vehicle.

11. The improvement of claim 4 wherein said verification means includes means for displaying at least one discrete signal received from the towing vehicle.

12. The improvement of claim 11, wherein said towing vehicle displayed discrete signal is selected from the group consisting of brake, running, left and right signals.

13. The improvement of claim 4 wherein said verification means displays at least one discrete signal received from said towed vehicle.

14. The improvement of claim 13 wherein said towed vehicle displayed discrete signal is selected from the group consisting of brake, running, left and right signals.

15. The improvement of claim 4 wherein said verification means includes a locator indicator.

16. The improvement of claim 4 wherein said verification means includes a power indicator.

17. The improvement of claim 1 wherein said wireless connector comprises Bluetooth apparatus.

18. The improvement of claim 1 wherein said wireless connector comprises radio frequency (RF) apparatus.

19. The improvement of claim 1 further comprising a towed vehicle power source operatively connected to said towed vehicle electrical system.

20. The improvement of claim 19 wherein said power source for said towed vehicle is rechargeable.

21. The improvement of claim 1 further comprising a locator chip operatively connected to and carried by said towed vehicle.

22. The improvement of claim 21 wherein said locator chip sends an active signal.

23. The improvement of claim 21 wherein said locator chip is passive.

24. The improvement of claim 1 wherein said wireless connection means includes internal random code writers whereby to assure signal independence, non-interference and integrity.

25. In a lighting control system between towing and towed vehicles, each having a respective lighting system, for enabling the towed vehicle to replicate the lighting condition of the towing vehicle, the improvement comprising:
lighting replication means including a signal connection means disposed between the respective lighting systems of the towing and towed vehicles, and further including transmitter and receiver means operatively and physically connected to said respective lighting systems of said towing and towed vehicles.

26. The improvement of claim 25 further comprising verification means operatively connected to at least one of said transmitter and receiving means for indicating signal interconnection therebetween.
